(19) United States
(12) Patent Application Publication
(10) Pub. No.: US 2017/0083681 A1
(43) Pub. Date: Mar. 23, 2017

(54) METHOD AND APPARATUS FOR GENERATING A CLINICAL PRESENTATION RELATED TO CONTROLLED SUBSTANCE ABUSE OR DIVERSION

(71) Applicants: Michael Phillip Sprintz, The Woodlands, TX (US); Ian M. Williamson, Pleasant Hill, CA (US)

(72) Inventors: Michael Phillip Sprintz, The Woodlands, TX (US); Ian M. Williamson, Pleasant Hill, CA (US)

(21) Appl. No.: 15/247,843

(22) Filed: Aug. 25, 2016

Related U.S. Application Data
(63) Continuation-in-part of application No. 14/391,341, filed on Oct. 8, 2014.
(60) Provisional application No. 62/209,739, filed on Aug. 25, 2015.
(60) Provisional application No. 61/765,704, filed on Feb. 16, 2013.
(60) Provisional application No. 61/841,280, filed on Jun. 29, 2013.

(51) Int. Cl. G06F 19/00

(52) U.S. Cl. CPC G06F 19/3431; G06F 19/3456; G06Q 2220/00

(57) ABSTRACT

Methods and systems of predicting abuse or diversion of one or more controlled substances are described. In an embodiment, a method may include identifying a potential abuser or diverter. The method may also include accessing one or more databases containing abuser or diverter data. Additionally, the method may include comparing said abuser or diverter data with data of abuse or diverter indicators. Further, the method may include assigning an abuse or diversion likelihood score to the potential abuser or diverter. Also, the method may include generating a graphical representation of the data obtained from the data source to provide information necessary to effectively evaluate a need for further prescriptions.

### CROSS-REFERENCE TO RELATED APPLICATIONS

This application claims priority to U.S. Provisional Patent Application No. 62/209,739, filed Aug. 25, 2015, entitled “METHOD AND APPARATUS FOR GENERATING A CLINICAL PRESENTATION RELATED TO CONTROLLED SUBSTANCE ABUSE OR DIVERSION,” the disclosure of which is incorporated by reference. The present application is also a continuation-in-part of U.S. patent application Ser. No. 14/391,341 filed on Oct. 8, 2014, which is a 371(c) nationalization of Patent Cooperation Treaty (PCT) Patent Application No. PCT/US 2014/016480, filed Feb. 14, 2014, entitled “METHODS AND SOFTWARE TO DETECT CONTROLLED SUBSTANCE ABUSE OR DIVERSION,” which claims priority from, U.S. Provisional Patent Application No. 61/765,704, filed Feb. 16, 2013, entitled “METHODS AND SOFTWARE TO DETECT CONTROLLED SUBSTANCE ABUSE OR DIVERSION”, and U.S. Provisional Patent Application No. 61/841,280, filed Jun. 29, 2013, entitled “METHODS AND SOFTWARE TO DETECT CONTROLLED SUBSTANCE ABUSE”, the disclosure of each of which is incorporated herein by reference.

### FIELD

The current invention relates to a software program for, and methods of, generating a clinical presentation related to potential controlled substance abuse, misuse, or diversion, and an apparatus for doing the same.

### BACKGROUND

The prescription drug abuse epidemic continues to surge in both its reach and its devastation, while the cost to federal, state, and local governments is staggering. For example, in 2005 federal, state, and local government spending as a result of substance abuse and addiction was at least $467.8 billion: $238.2 billion, federal; $135.8 billion, state; and $93.8 billion, local. Total government spending of $467.8 billion on substance abuse and addiction amounted to 10.7 percent of their entire $4.4 trillion budgets.

In that same year, for every taxpayer dollar spent on substance abuse, 95.6 cents went to treating the consequences, while only 1.9 cents was spent on prevention and treatment, 0.4 cents was spent on research, 1.4 cents was spent on taxation or regulation, and 0.7 cents was spent on interdiction.

The wreckage extends far beyond the State's coffers and insurer's bottom lines. Overdose deaths from prescription drugs are now the number one cause of accidental death in this country. With 80-90% of the prison population with an alcohol or drug problem or related crime, untreated drug and alcohol abuse drives crime, fatalities, victimization, auto accidents, and an ever-expanding financial drain on our criminal justice and healthcare systems. The number of babies born with neonatal abstinence syndrome continues to increase, along with the astronomical costs of caring for these newborns, often severely premature and the life-long medical complications that result from being born premature and addicted. Meanwhile, the precious and limited resources are being spent reactively on the consequences of substance abuse rather than the economically-sound model of using such resources for the prevention, treatment, and long-term management of drug and alcohol abuse.

Spending of addiction treatment was estimated at $28 billion in 2010, with public payers contributing 79.2% of the bill. State and local governments spent $229 billion dollars on the consequences of addiction and only $12.6 billion on treatment of the disease.

State-funded programs such as Medicaid and the criminal justice system are hemorrhaging money trying to handle the consequences of their covered populations' substance abuse problem without a reasonable, effective strategy to address the current problem, nor any plan to prevent more of the same.

As State budgets tighten in this challenging economic environment, funding for addiction treatment and preventive services will continue to get cut, worsening the problem and causing a vicious downward spiral of economic and social consequences.

The role of state prescription drug monitoring programs (PDMPs) in facilitating appropriate prescribing of controlled prescription drugs and helping to address the prescription drug abuse or diversion epidemic has been highlighted in recent studies and in the 2011 White House Office of National Drug Control Policy's Prescription Drug Abuse Prevention Plan (GAO, 2002; Pradel et al., 2009; Baehren et al., 2010; Katz et al., 2010; Johnson et al., 2011; Office of National Drug Control Policy, 2011).

A PDMP is a statewide electronic database that gathers information from pharmacies on dispensed prescriptions for controlled substances (most states that permit practitioners to dispense also require them to submit prescription information to the PDMP). Many PDMPs now provide secure online access to this information for authorized recipients. Prescription data (usually for the past year, and including information on date dispensed, patient, prescriber, pharmacy, medicine, and dose) is made available on request from end users, typically prescribers and pharmacists, and sometimes is distributed via unsolicited reports. Recipients of PDMP data may also include practitioner licensure boards, law enforcement and drug control agencies, medical examiners, drug courts and criminal diversion programs, addiction treatment programs, public and private third-party payers, and other public health and safety agencies. States vary widely in which categories of users are permitted to request and receive prescription history reports and under what conditions.

While PDMPs contain useful information, several impediments may hinder prescribers and dispensers from accessing or using this information. There are multiple problems with current State PDMP programs that result in their lack of use. For example, many PDMPs do not actively monitor and notify, their data is not current or in real time, and they lack a process of making automated queries. From a clinical workflow perspective, the information downloaded from PDMP's is raw data, thus requiring the end-user to attempt to interpret the data, which can sometimes be more that 20-30 pages, and make clinical decisions based on that in a short time period. Not only is the current PDMP output time-consuming to the end-user and delivered in a raw, “data dump” format, it can also be confusing, since most providers are not trained in interpreting or analyzing PDMP data to assess risk of abuse or diversion of prescription drugs. Meanwhile, laws in many states continue to be enacted mandating some level of access to PDMPs when treating patients with controlled prescription drugs. The prior systems make compliance with such mandates challenging at best. These issues, among others, are addressed by the current invention.

### SUMMARY

Methods and systems of predicting abuse or diversion of one or more controlled substances are described. In an embodiment, a method may include identifying a potential abuser or diverter. The method may also include accessing one or more databases containing abuser or diverter data. Additionally, the method may include comparing said abuser or diverter data with data of abuse or diverter indicators. Further, the method may include assigning an abuse or diversion likelihood score to the potential abuser or diverter. Also, the method may include generating a graphical representation of the data obtained from the data source to provide information necessary to effectively evaluate a need for further prescriptions.

### DETAILED DESCRIPTION

The following drawings form part of the present specification and are included to further demonstrate certain aspects of the present invention. The invention may be better understood by reference to one or more of these drawings in combination with the detailed description of specific embodiments presented herein.

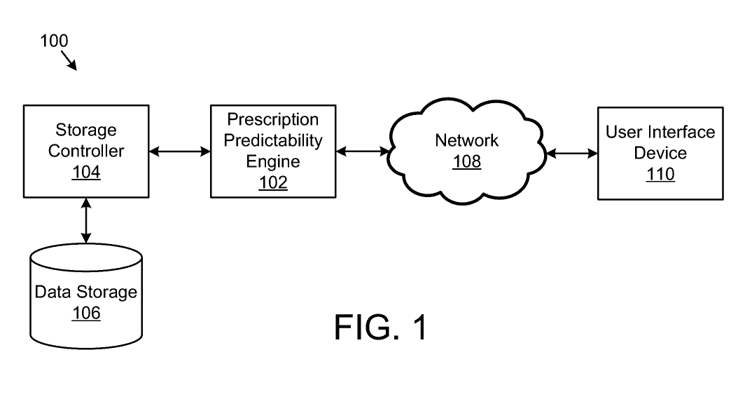

FIG. 1 is a schematic block diagram illustrating one embodiment of a system for generating a clinical presentation related to controlled substance abuse and diversion.

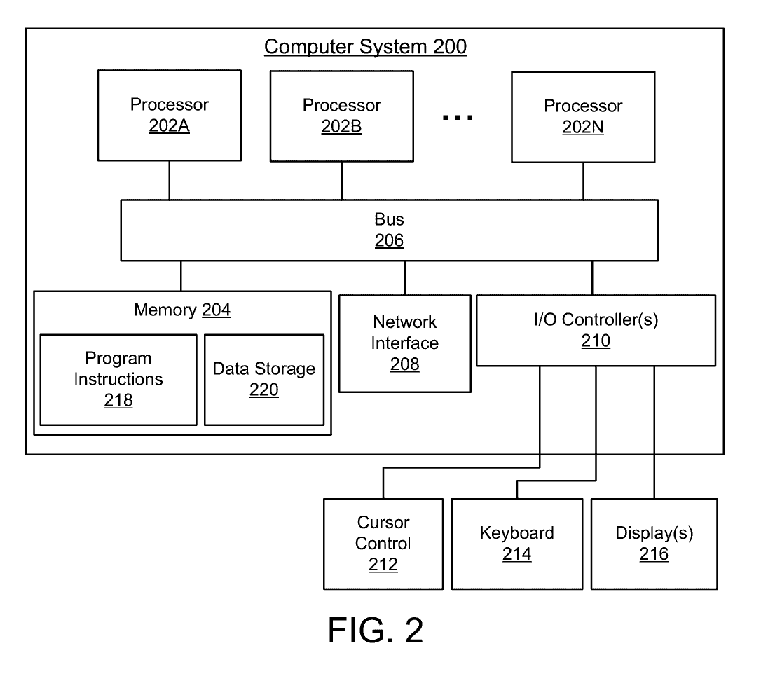

FIG. 2 is a schematic block diagram illustrating one embodiment of a system for generating a clinical presentation related to controlled substance abuse and diversion.

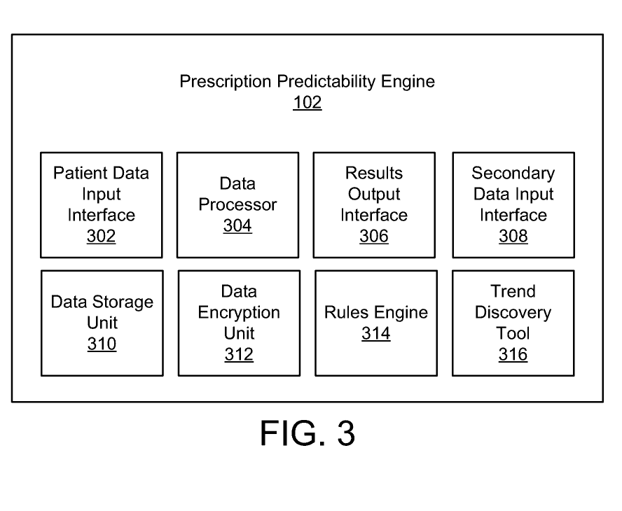

FIG. 3 is a schematic block diagram illustrating one embodiment of an apparatus for generating a clinical presentation related to controlled substance abuse and diversion.

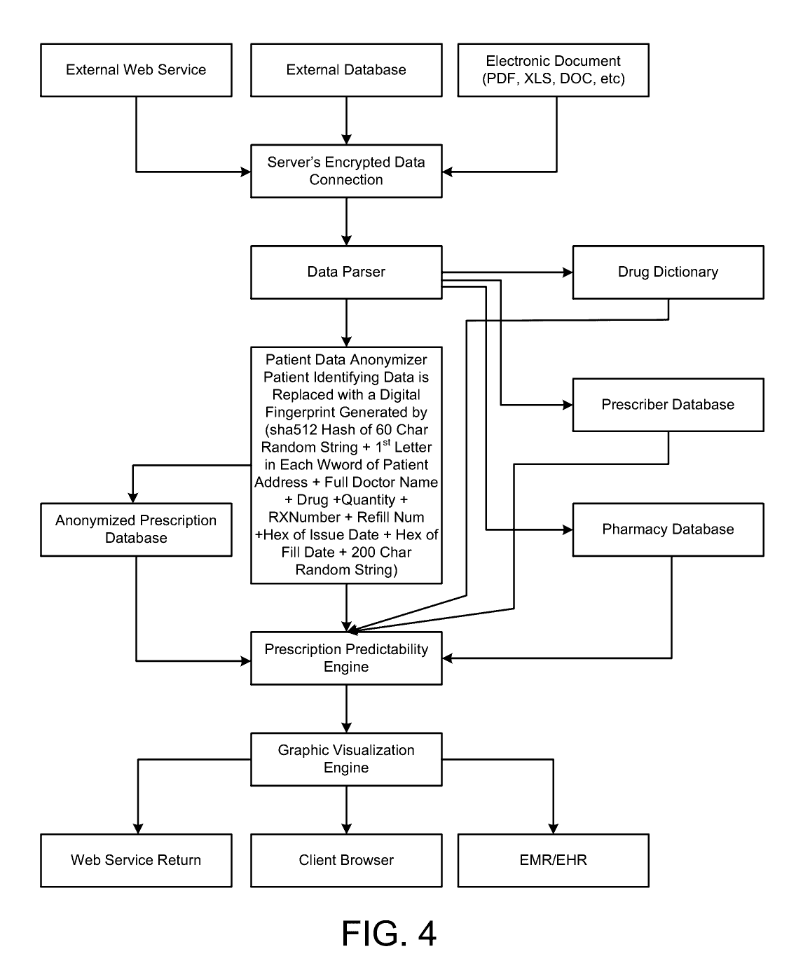

FIG. 4 is a flowchart diagram illustrating one embodiment of a method for generating a clinical presentation related to controlled substance abuse and diversion.

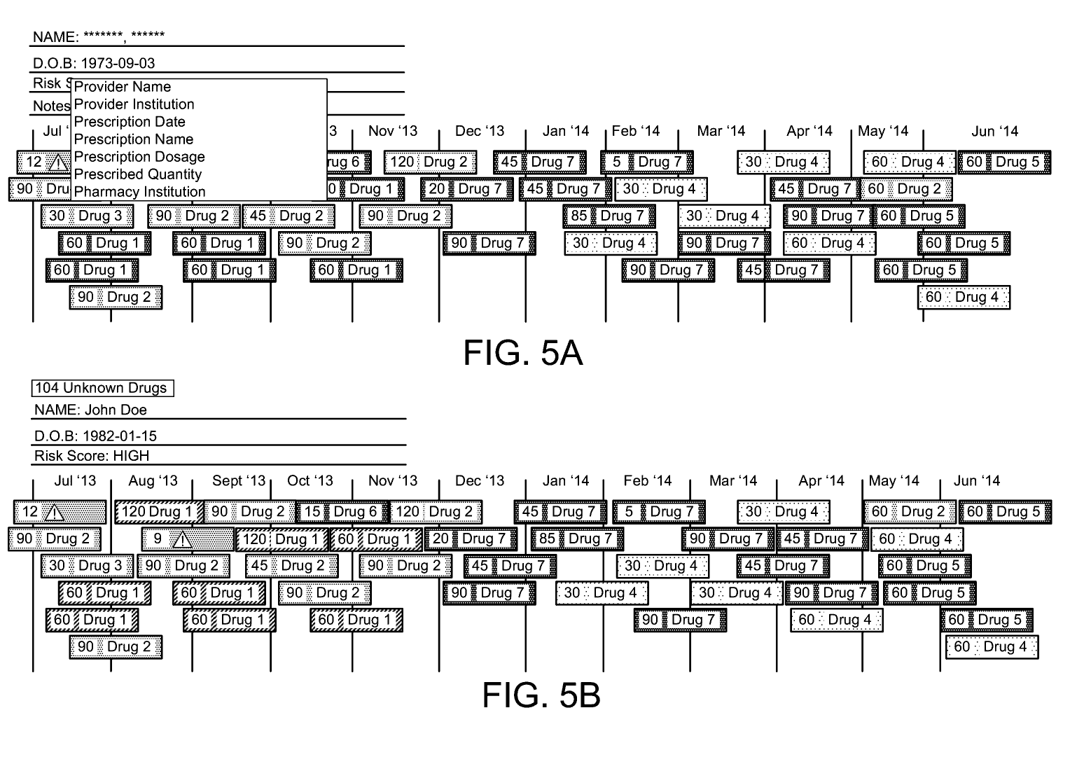

FIG. 5A is a screenshot diagram illustrating one embodiment of a clinical presentation related to controlled substance abuse and diversion.

FIG. 5B is a screenshot diagram illustrating one embodiment of a clinical presentation related to controlled substance abuse and diversion.

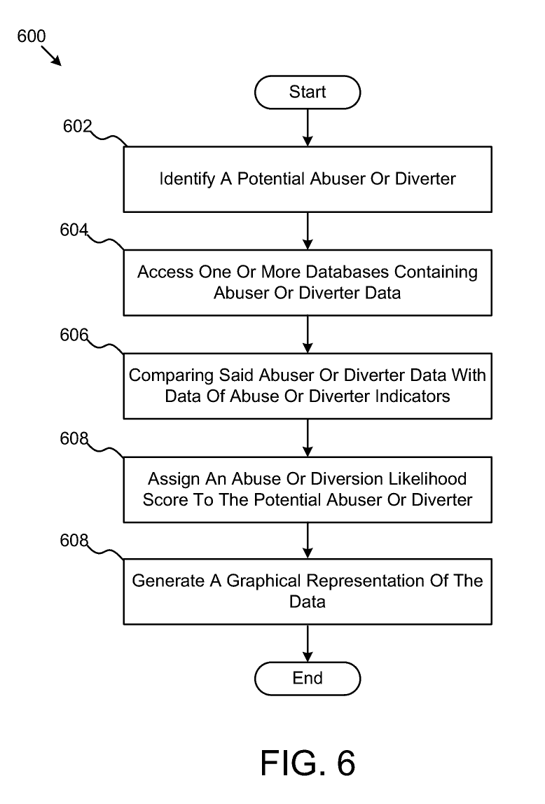

FIG. 6 is a flowchart diagram illustrating one embodiment of a method for generating a clinical presentation related to controlled substance abuse and diversion.

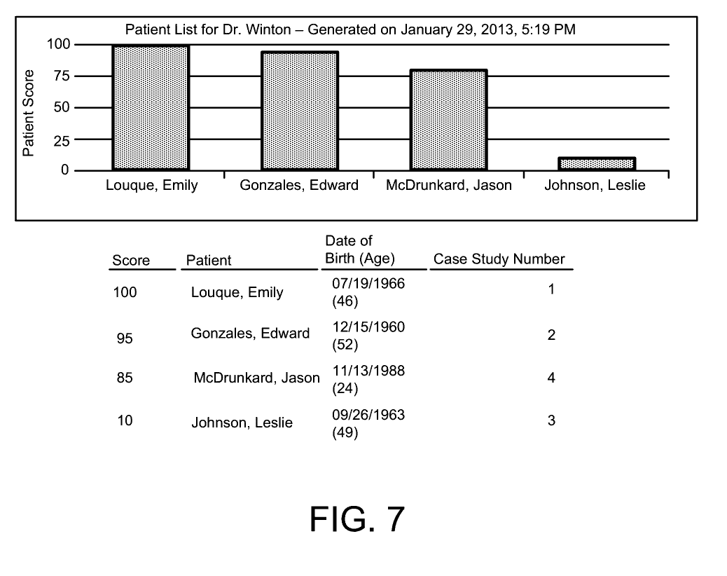

FIG. 7 shows an exemplary screenshot of a physician's desktop, where scores associated with a specific set of patients are displayed.

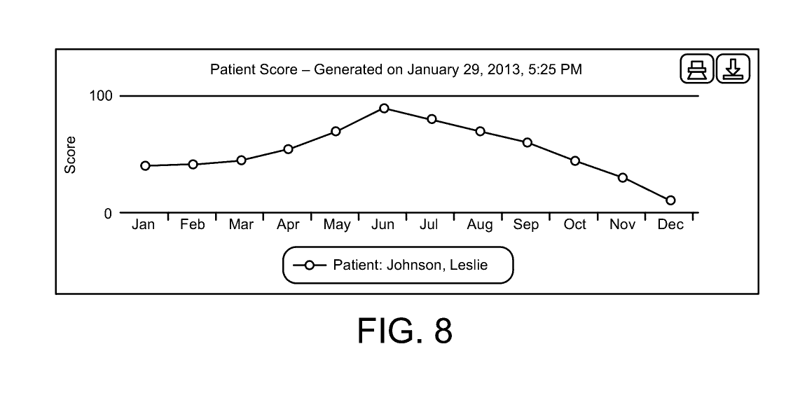

FIG. 8 is a timeline display of a patient's score; the graph indicates a pattern of compliance after corrective action taken when the score had peaked.

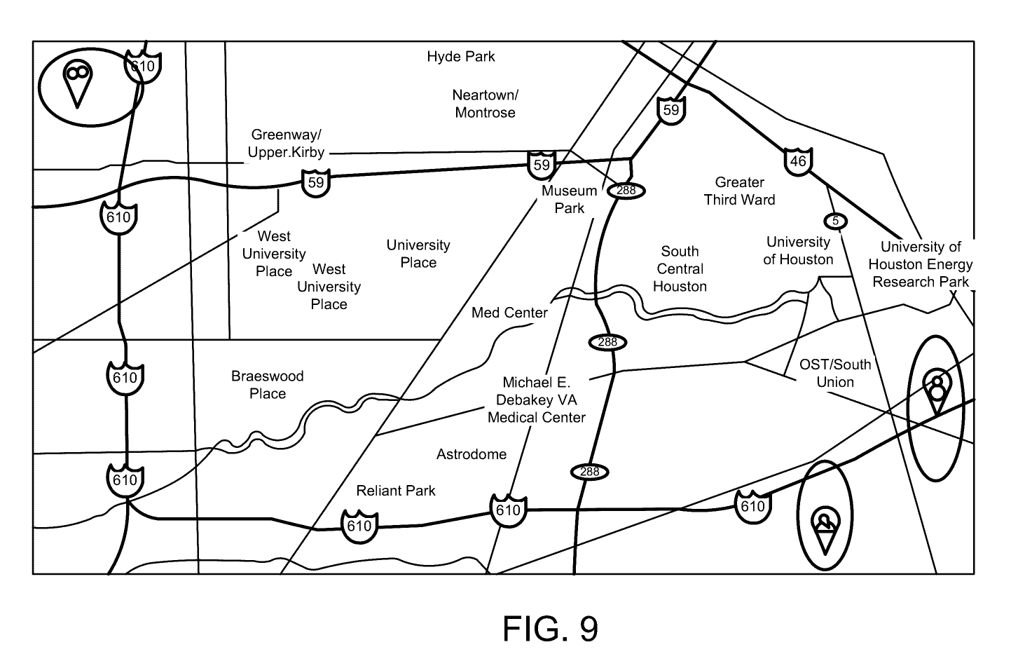

FIG. 9 is a display of locations on a map; this figure shows the patient's location on the right corner of the figure, the physician's location at the bottom of the figure, and the pharmacy location at the upper left corner.

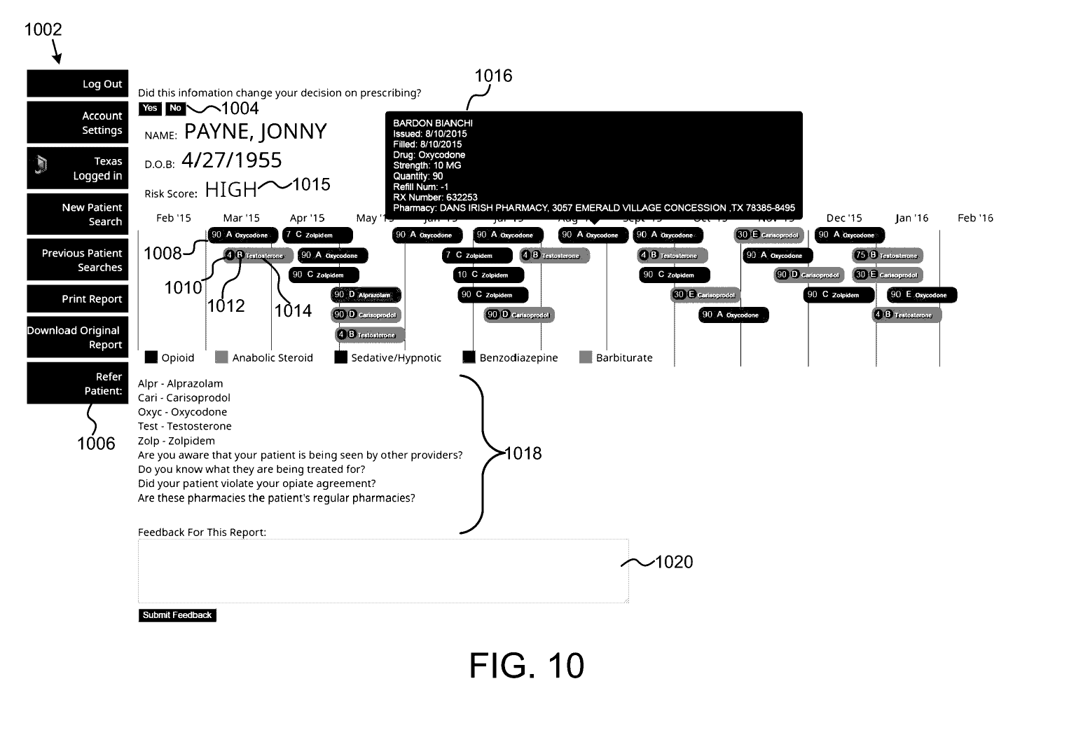

FIG. 10 is a screenshot diagram illustrating one embodiment of a user interface screen produced by a system for generating a clinical presentation related to controlled substance abuse and diversion.

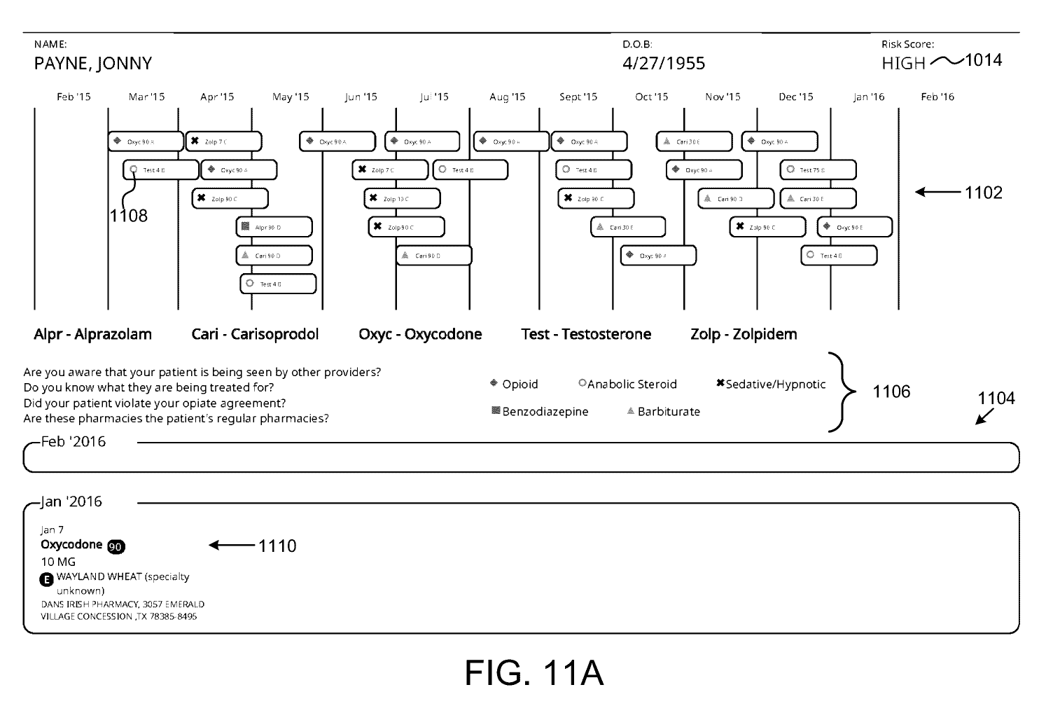

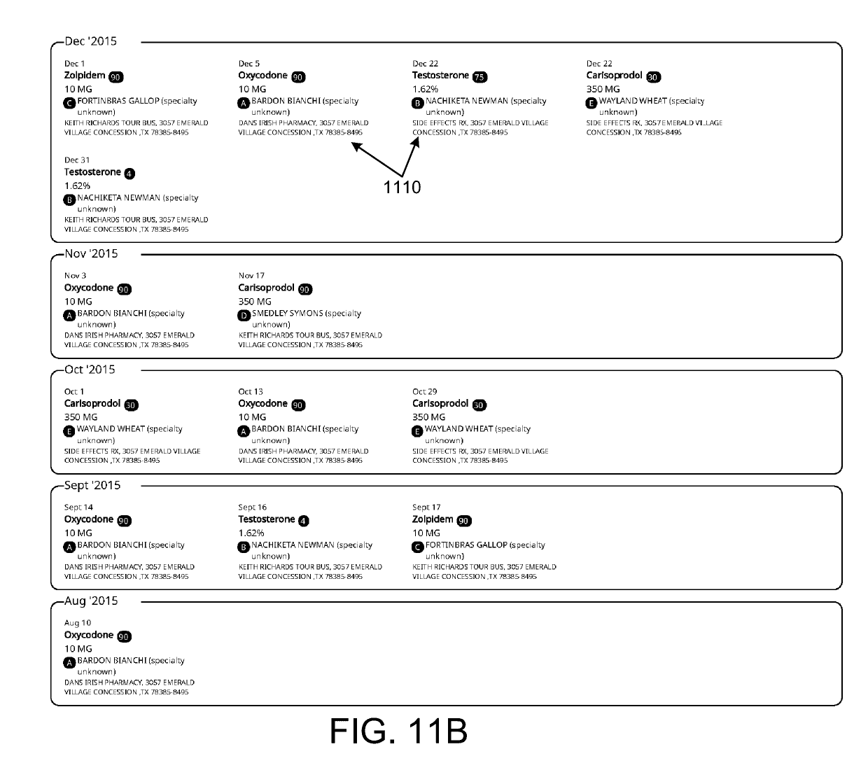

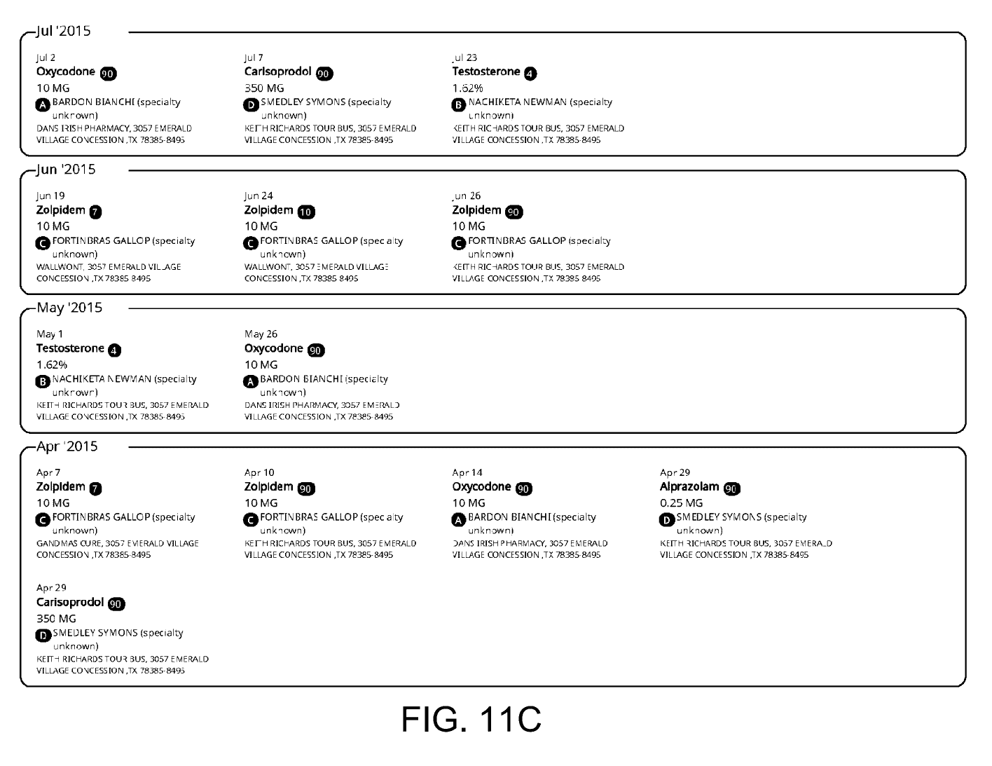

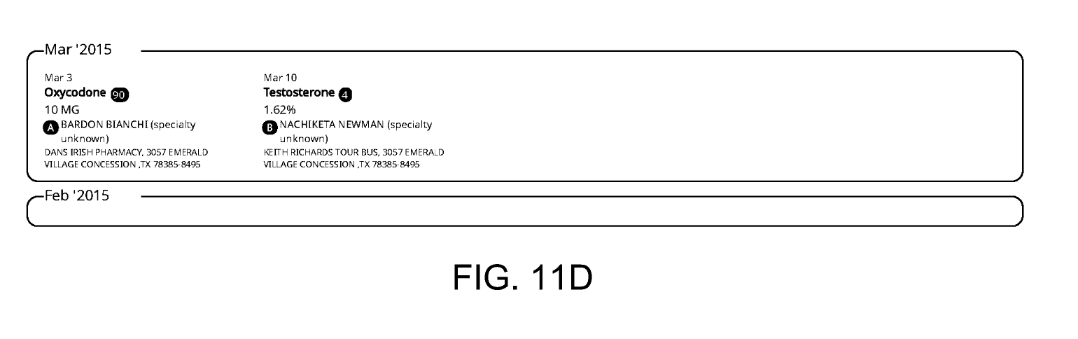

FIG. 11A is a screenshot diagram illustrating one embodiment of a report produced by a system for generating a clinical presentation related to controlled substance abuse and diversion.

FIG. 11B is a screenshot diagram illustrating one embodiment of a report produced by a system for generating a clinical presentation related to controlled substance abuse and diversion.

FIG. 11C is a screenshot diagram illustrating one embodiment of a report produced by a system for generating a clinical presentation related to controlled substance abuse and diversion.

FIG. 11D is a screenshot diagram illustrating one embodiment of a report produced by a system for generating a clinical presentation related to controlled substance abuse and diversion.

### DETAILED DESCRIPTION

Various features and advantageous details are explained more fully with reference to the nonlimiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Unless defined otherwise, all technical and scientific terms used herein have the same meaning as commonly understood by one of ordinary skill in the art.

The term “controlled substance”, as used herein, without limitation, is with reference to drugs, prodrugs, precursors, or substances, the prescription and administration of which is regulated. This definition also includes alcohol, tobacco products, nicotine delivery systems, pseudoephedrine, and the like, which do not require a prescription, but are either regulated or have relevance to detection of abuse or diversion.

The term “potential abuser or diverter”, as used herein, without limitation, may be any person, institution, or a business that may interact with a controlled substance. In one instance the potential abuser or diverter is a patient, in another instance the potential abuser or diverter is a prescriber, and in yet another instance the potential abuser or diverter is a dispenser. In some instances, the potential abuser or diverter is an institution, and in another instance the potential abuser or diverter is a legal business, and it yet another instance the potential abuser or diverter is an illegal business.

The term “data of indicators”, as used herein, without limitation, means one or more features or groups of features, which can be (or can be used as) predictors of abuse or diversion.

The term “abuse or diversion likelihood score”, as used herein, without limitation, can be a numerical value assigned to a potential abuser or diverter. This numerical value may further be color coded; for example: a high value may be coded with red.

The term “patient”, as used herein, without limitation, includes any person who may seek, or is given, a controlled substance for self or for others. Others may be humans or non-humans.

The term “prescriber”, as used herein, without limitation, includes any individual or entity prescribing controlled substances.

The term “dispenser”, as used herein, without limitation, includes any individual or entity that fills a prescription or dispenses a medication or controlled substance, including for example, sample medications dispensed in a medical office setting.

The term “user”, as used herein, without limitation, may be any individual or entity. In some cases, the methods disclosed in this application may also be used (or interfaced) with other software. In such cases the “user” is a program or software.

The term “computer readable medium”, without limitation, includes any medium that can store or transfer information, including volatile, nonvolatile, removable and non-removable media.

The term “processor” refers, without limitation, generally to any programmable system including systems and microcontrollers, reduced instruction set circuits (RISC), application specific integrated circuits (ASIC), programmable logic circuits (PLC), and any other circuit or processor capable of executing functions or programs.

The term “pull notification” refers to the mode of interaction wherein the user requests the information.

The term “push notification” refers to the mode of interaction wherein the user is mostly passive; the decision to provide information is made without the user making continuous requests.

Some terms used herein are also defined in Title 21 Code of Federal Regulations (C.F.R.) §1300.1, which is incorporated herein by reference.

FIG. 1 is a schematic block diagram illustrating one embodiment of a system 100 for generating a clinical presentation related to controlled substance abuse and diversion. The system 100 may include a Prescription Predictability Engine (PPE) 102, a data storage device 104, a network 108, and a user interface device 110. In a further embodiment, the system 100 may include a storage controller 106, or storage server configured to manage data communications between the data storage device 104, and the server 102 or other components in communication with the network 108. In an alternative embodiment, the storage controller 106 may be coupled to the network 108. In a general embodiment, the system 100 may be configured such that the PPE 102 obtains patient prescription usage data from an internal or external data source, such as a Prescription Drug Monitoring Program (PDMP) report. Specifically, the system 100 may utilize information from such data sources to calculate a risk score associated with the patient, where the risk score is an indicator of a level of risk associated with prescribing a prescription drug, such as a controlled substance, to the patient. Additionally, the system may generate a graphical representation of the data obtained from the data source to provide a health service provider with information necessary to effectively discuss the patient's prescription drug history and to more effectively evaluate the patient's need for further prescriptions, and assist with or improve the clinical decision-making.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the PPE 102, which in some embodiments may be a server coupled to the network 108, and provide a user interface for enabling a user to enter or receive information associated with a patient's prescription drug history. For example, the user may enter instructions for pharmacies, updates PDMP systems, information for internal patient records, official acknowledgments of review of PDMP system information, or the like.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is configured to obtain PDMP or other prior medication prescription information related to a patient, analyze the information to determine a risk score and other information for presentation to a provider, and generate a graphical representation of the patient's prescription history that includes the risk score and a chronological listing of classified prescriptions to the provider. Additionally, the server may access data stored in the data storage device 104 via a Storage Area Network (SAN) connection, a LAN, a data bus, or the like.

The data storage device 104 may include a hard disk, including hard disks arranged in a Redundant Array of Independent Disks (RAID) array, an optical storage device, or the like. In one embodiment, the data storage device 104 may store health related data, such as insurance claims data, consumer data, or the like. The data may be arranged in a database and accessible through Structured Query Language (SQL) queries, or other data base query languages or operations.

FIG. 2 is a schematic block diagram illustrating one embodiment of a system 200 for generating a clinical presentation related to controlled substance abuse and diversion. In one embodiment, the user interface device 110 and/or the PPE 102 may be implemented on a computer system similar to the computer system 200 described in FIG. 2. In various embodiments, computer system 200 may be a server, a mainframe computer system, a workstation, a network computer, a desktop computer, a laptop, or the like.

As illustrated, computer system 200 includes one or more processors 202A-N coupled to a system memory 204 via bus 206. Computer system 200 further includes network interface 208 coupled to bus 206, and input/output (I/O) controller(s) 210, coupled to devices such as cursor control device 212, keyboard 214, and display(s) 216. In some embodiments, a given entity (e.g., PPE 102, or user interface device 110) may be implemented using a single instance of computer system 200, while in other embodiments multiple such systems, or multiple nodes making up computer system 200, may be configured to host different portions or instances of embodiments (e.g., PPE 102).

In various embodiments, computer system 200 may be a single-processor system including one processor 202A, or a multi-processor system including two or more processors 202A-N (e.g., two, four, eight, or another suitable number). Processor(s) 202A-N may be any processor capable of executing program instructions. For example, in various embodiments, processor(s) 202A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 202A-N may commonly, but not necessarily, implement the same ISA. Also, in some embodiments, at least one processor(s) 202A-N may be a graphics processing unit (GPU) or other dedicated graphics-rendering device.

System memory 204 may be configured to store program instructions and/or data accessible by processor(s) 202A-N. For example, memory 204 may be used to store software program and/or database shown in FIGS. 3-4. In various embodiments, system memory 204 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 204 as program instructions 218 and data storage 220, respectively. In other embodiments, program instructions and/or data may be received, sent or stored upon different types of computer-accessible media or on similar media separate from system memory 204 or computer system 200. Generally speaking, a computer-accessible medium may include any tangible, non-transitory storage media or memory media such as electronic, magnetic, or optical media—e.g., disk or CD/DVD-ROM coupled to computer system 200 via bus 206, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 206 may be configured to coordinate I/O traffic between processor 202, system memory 204, and any peripheral devices including network interface 208 or other peripheral interfaces, connected via I/O controller(s) 210. In some embodiments, bus 206 may perform any necessary protocol, timing or other data transformations to convert data signals from one component (e.g., system memory 204) into a format suitable for use by another component (e.g., processor(s) 202A-N). In some embodiments, bus 206 may include support for devices attached through various types of peripheral buses, such as a variant of the Peripheral Component Interconnect (PCI) bus standard or the Universal Serial Bus (USB) standard, for example. In some embodiments, the operations of bus 206 may be split into two or more separate components, such as a north bridge and a south bridge, for example. In addition, in some embodiments some or all of the operations of bus 206, such as an interface to system memory 204, may be incorporated directly into processor(s) 202A-N.

Network interface 208 may be configured to allow data to be exchanged between computer system 200 and other devices, such as other computer systems attached to network 108, for example. In various embodiments, network interface 208 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 210 may, in some embodiments, enable connection to one or more display terminals, keyboards, keypads, touch screens, scanning devices, voice or optical recognition devices, or any other devices suitable for entering or retrieving data by one or more computer system 200. Multiple input/output devices may be present in computer system 200 or may be distributed on various nodes of computer system 200. In some embodiments, similar I/O devices may be separate from computer system 200 and may interact with computer system 200 through a wired or wireless connection, such as over network interface 208.

As shown in FIG. 2, memory 204 may include program instructions 218, configured to implement certain embodiments described herein, and data storage 220, comprising various data accessible by program instructions 218. In an embodiment, program instructions 218 may include software elements of embodiments illustrated in FIGS. 3-4. For example, program instructions 218 may be implemented in various embodiments using any desired programming language, scripting language, or combination of programming languages and/or scripting languages. Data storage 220 may include data that may be used in these embodiments such as, for example, PDMP report information, etc. In other embodiments, other or different software elements and data may be included.

A person of ordinary skill in the art will appreciate that computer system 200 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

Embodiments of the PPE 102 described in FIG. 1 may be implemented in a computer system that is similar to computer system 200. In one embodiment, the elements described in FIGS. 3-4 may be implemented in discrete hardware modules. Alternatively, the elements may be implemented in software-defined modules which are executable by one or more of processors 202A-N, for example.

FIG. 3 is a schematic block diagram illustrating one embodiment of an apparatus for generating a clinical presentation related to controlled substance abuse and diversion. In an embodiment, the PPE 102 includes a patient data input interface 302, a data processor 304, a results output interface 306, a secondary data input interface 308, a data storage unit 310, a data encryption unit 312, a rules engine 314, and a trend discovery tool 316.

In an embodiment, patient data is received by the patient data input interface 302. Patient data can come from a variety of sources before being converting into the PPE input data model. In some embodiments, the PPE 102 may support the ASAP WS standard as well as a proprietary PDF parser to extract data from the PDMP output formats for individual states. In a particular embodiment, the PDF parser supports the Texas PDMP. One of ordinary skill will recognize that support for PDMP reports from other states, or for other drug-related reports or information may be supported according to the present embodiments. In addition, the PPE can support a number of secured web services where a customer can pass data in the PPE input data model to the PPE server 102 directly.

The data processor 304 may process the data received by the patient data input interface 302. For example, the PPE 102 processes it through a series of calculations to generate more data for the Rules Engine 314 to use. Initially the PPE tracks the number of doctors, addresses, pharmacies and prescriptions a patient has, but in addition, the PPE 102 may organize each prescription into the drug's class, and using the quantity along with the written and fill date, the system can build a timeline of the patient's drug history. The PPE 102 also looks up the geographical coordinates for every address to validate its existence as well as measuring the variations in distance a patient has between doctors and pharmacies. The PPE 102 also utilizes an algorithm to generate a score of how predictable many changing factors in a patient's data are, like patient address changes, different doctors (as well as different doctors prescribing the same class of drug), drug dosage and qualities, etc. The risk score may relate to a patient's risk of a possible substance use disorder or diversion of prescription medications, and embodiments of the algorithm to generate a score are described in greater detail below.

Once the patient's data can be processed, a resulting risk factor is returned to the doctor, along with enough data to support the risk factor using the output interface 306. The supporting data may include a graphical timeline of the patient's prescriptions over time, with graphic indicators showing the written date, the fill date as well as a calculated length of the prescription as illustrated in FIG. 5. This graphical view gives a quick view into the patient's behavior. Other supporting data includes the number of various drug classes prescribed to the patient, as well as any relevant questions and statements of which the system is configured to inform the user.

In addition to the data that is mined from a primary data source, such as a PDMP report, the secondary data input interface 308 of the PPE 102 can prompt doctors with questions, the answers to which may be reintroduced into the risk calculation to refine the results as well as expand the pool of collected data. Examples of questions may include clinical observations of the patients physical and emotional appearance, whether the provider has seen the patient before within a predetermined period of time, etc. Other external data sources can be utilized are described in greater detail below.

In an embodiment, the data storage unit 310 combine the secondary data calculations with the input data, and all identifying data, patient's name, date of birth, address, etc, are excluded from what gets recorded in the PPE database. Such data may be used for generating averages and looking for statistical sound patient behavioral data, which is available to be utilized in PPE rules. In addition, the secondary data for each doctor and pharmacy is recorded for the purposes of discovering members of each that have a higher than average number of high risk patients. Additionally, such secondary data may also be used to help identify prescribers or pharmacies that may be prescribing or dispensing controlled prescription drugs inappropriately or for non-therapeutic medical purposes.

For the PPE averaging system to work, a patient's prescription can only be recorded once in our system. Multiple processing of the same prescription needs to be ignored to avoid contamination of the data pool used for behavioral averaging. To enable this while still protecting patient's privacy, each script is one way encrypted by the data encryption unit 312 with a combination of data that makes it a unique fingerprint without storing any personal data.

The PPE rule engine may 314 may include a collection of defined conditions used to judge the input data by. The rules can vary from a simple “if patient's age is less than 35, add 40 points” to “if patient's quantity of opioids is greater than 90 at 2.5 mg and the time between refills is over 40 days and they reside in a warm state and it is 10% over the average, add 15 points.”

Each rule is defined by the conditions the data needs to match and the resulting output can be scaled to between a minimum value up to the maximum. The PPE tracks the sum of the scores from the rules that have qualifying data to determine the final risk score.

Rules are created and modified using the Rule Editor, a subsystem of the PPE only available to system administrators. Rules can be edited and an Admin can see the results of the changes in real time before committing them to the main PPE.

Paired with the Rules Editor, the trend discovery tool 316 may create complex search queries for the discovery of trends in medium and high-risk patients. Using the stored data from every patient's PDMP report run, this tool is key in refining the PPE 102.

An embodiment of a processing flow for operations carried out by the units described in FIG. 3 is illustrated in FIG. 4. The illustrated method flow shows various data sources, which may be used in association with the present embodiments. For example, primary data sources may include web services, databases, or electronic documents from PDMP systems. The data may be encrypted, parsed, and anonymized to comply with federal and state patient protection requirements. Additional data may be obtained from secondary sources, such as a drug dictionary, a prescriber database, a pharmacy database, or the like. The data may be processed, and a graphic visualization of the data and/or risk score may be generated for rendering by a client device, such as a web service return, a web client, or a mobile data device.

FIG. 5A is a screenshot diagram illustrating one embodiment of a clinical presentation related to controlled substance abuse and diversion. The graphic may include patient information, such as name, date of birth, patient number, etc. Additionally, the graphic may include some indicator of the risk score. For example, the risk score may be an alphanumeric value, a label of “High,” “Medium,” or “Low,” a color code such as red, yellow, green, an icon value such as a stop sign, or the like. One of ordinary skill will recognize a variety of options for representing the risk score. Additionally, the graphic may include a timeline of prescriptions received by the patient. The timeline may include multiple entries, such as bubbles, boxes, circles, or the like, which contain information about the prescription, such as the name of the prescribed drug, the quantity of pills dispensed, the identification of the prescribing physician, and the like. Additionally, the entries may be coded to indicate the class of drugs prescribed. For example, each entry in the timeline may be color coded, where the color indicates the class of drug. A drug which is classified under multiple classes may have a multi-color code, as represented in FIG. 5B with striped cross-hatch.

FIG. 6 illustrates one embodiment of a method 600 for predicting abuse or diversion of one or more controlled substances. In an embodiment, a method 600 may include identifying a potential abuser or diverter, as shown at block 602. The method 600 may also include accessing one or more databases containing abuser or diverter data, as shown at block 604. Additionally, the method 600 may include comparing said abuser or diverter data with data of abuse or diverter indicators, as shown at block 606. Further, the method 600 may include assigning an abuse or diversion likelihood score to the potential abuser or diverter, as shown at block 608. Also, the method 600 may include generating a graphical representation of the data obtained from the data source to provide information necessary to effectively evaluate a need for further prescriptions, as shown at block 610.

Further methods of predicting abuse or diversion of one or more controlled substances are also included. Such methods include identifying a patient, accessing one or more databases containing patient data, comparing patient data with data of indicators of abuse or diversion, and assigning an abuse or diversion likelihood score to the patient.

The patient may be identified by a user of this method, where the user is any individual or a program (which may be run by a person or scheduled to run automatically).

In one aspect, the databases containing patient data, without limitation, incorporate data provided by a regulatory authority. The regulatory authority, without limitation, in one instance is a drug testing authority (government or non-government), a law enforcement authority, a legal system, a healthcare licensing or healthcare credentialing authority, a state medical board, a state pharmacy board, a state nursing board, a state veterinary board, a state chiropractic board, a state dental board, a state podiatry boards, a department of transportation, a state bar, or the like.

In another aspect, the databases containing patient data incorporate data provided, without limitation, by a prescription or a prescriber. The prescriber, without limitation, can be a doctor, a physician assistant, a nurse practitioner, a dentist, a veterinarian, a podiatrist, a chiropractor, any individual or entity legally authorized to prescribe controlled substances, or any individual or entity ill-legally prescribing a controlled substance.

In another aspect, the databases containing patient data incorporate data provided, without limitation, by a dispenser. The dispenser, without limitation, can be a pharmacy, a pharmacist, a physician or a physician's authorized agent, such as a nurse practitioner or physician assistant dispensing under the license of the physician.

In another aspect, the databases containing patient data incorporate data provided, without limitation, by a supplier. The supplier, without limitation, can be a brand name supplier, a generic supplier, a pharmacy warehouse, a wholesaler, or a distributer.

In another aspect, the databases containing patient data incorporate data provided, without limitation, by a compounder, an importer, an exporter, a manufacturer, a toxicology report, a drug-testing or a clinical laboratory, or a healthcare provider.

In another aspect, the databases containing patient data incorporate data provided, without limitation, by an insurance provider or third-party payer, a government agency, a credit bureau, a research organization, a pharmacy or healthcare benefits manager, a Health Information Exchange (HIE), an electronic medical record (EMR) or electronic healthcare record (EHR), a pharmacy benefits manager, a financial institution, a communications company, an internet or web-based services provider (hosting, data tracking, search engines, a mobile device content or advertisement provider), a GPS or other location-tracking provider, a face-recognition or other bio-identification company, a surveillance company, a security company, or a data analytics company.

In another aspect, the databases containing patient data incorporate data provided, without limitation, by user input. In a further aspect, the data of indicators may include, without limitation, data relating to a controlled substance. The controlled substance, without limitation, may be any substance as defined by the Drug Enforcement Administration (DEA) in Title 21 Code of Federal Regulations (C.F.R.) §§1308.11 through 1308.15. The lists of Schedule I-V controlled substances are herein incorporated by reference. Any other drug, alcohol, and beverages thereof that can be abused or diverted are also considered as controlled substances.

In general Schedule I-Schedule V drugs are assigned priority—high to low, in the same order, for the purpose of assigning an abuse or diversion likelihood score. The following drugs are also given higher priority for the purpose of assigning abuse or diversion likelihood score: opiates/opioids such as hydrocodone, oxycodone, morphine, fentanyl, buprenorphine, suboxone (buprenorphine/naloxone), codeine, hydromorphone and methadone; muscle relaxants such as carisoprodol (soma); CNS depressants such as Benzodiazepines (examples: alprazolam, lorazepam, clonazepam, diazepam), Baribiturates (examples: phenobarbital, Nembutal, butalbital, and amobarbital), and other sedative/hypnotics such as zolpidem; CNS stimulants such as amphetamine, methamphetamine, methylphenidate, phentermine, modafanil (provigil) and armodafanil (nuvigil); and anabolic steroids. This list is not all-inclusive and may cover all controlled substances currently regulated by the U.S. Controlled substances Act, as well as new compounds that may have any abuse or diversion or diversion potential.

In another aspect, the data of indicators may include, without limitation, data relating to a diagnosis of substance abuse or diversion, substance dependence, process addictions, such as food addiction, gambling addiction, internet addiction, pornography addiction, sex addiction, video game addiction, exercise addiction; unipolar disorder, bipolar disorder, post-traumatic stress disorder (PTSD), anorexia, bulimia, schizophrenia, mood disorder, personality disorders, sociopathy, psychopathy, ADHD or ADD, cancer, and terminal cancer.

In another aspect, the data of indicators may include, without limitation, data corresponding to a behavior, such as possessing drugs for addiction or precursors thereof, substance abuse or diversion, misuse, dependence, diversion of controlled substances, and smoking.

In another aspect, the data of indicators may include, without limitation, data relating to a CPT (Current Procedural Terminology) code, an International Classification of Diseases code (ICD-9, ICD-10, and all future versions of diagnosis codes), evaluation and management (E&M) codes, a procedure, a disciplinary action, a legal judgment, a laboratory test or result, a disorder, a condition or a syndrome, a bio-identification marker, an image, a document, suppliers, importers, exporters, manufacturers, or compounders.

In another aspect, the data of indicators may include, without limitation, data corresponding to a record, which includes a history of positive drug test, a drug related criminal record, a non-drug related criminal record, a DUI conviction, a multiple DUI conviction, a family history of substance abuse or diversion, police reports related to stolen or missing prescriptions or controlled substances, or a history of non-drug related abuse or diversion (abusing or being abused).

In another aspect, the data of indicators may include, without limitation, data corresponding to a timeline, such as frequency of emergency room visits, high number of prescribers in a short period, high number of doses during a short period, more than one payment within a short period, frequency and length of overlapping prescriptions, frequency of unhealthy combinations of controlled substances, frequency of an out of state prescriber, more than one method of payment in a short time, more than of one pharmacy on the same day, more than one pharmacy in different health districts in one month, frequency of multiple controlled substance prescriptions from more than one prescriber, frequency of multiple controlled substance prescriptions from one prescriber, frequency of opioid prescriptions, or frequency of multiple, early refills and combinations thereof.

In another aspect, the data of indicators may include, without limitation, data corresponding to a prescription, which includes the number of prescriptions for opioids, prescription for controlled substance without an ICD code for a diagnosis warranting such a prescription, and total number of prescriptions.

In another aspect, the data of indicators may include, without limitation, data corresponding to prescribers, which includes number of prescribers, prescribers with a incidence of high controlled substance prescription, prescribers with unusual prescribing patterns, prescribers self-prescribing controlled substances, percentage of controlled prescriptions prescribed, prescribers with history of medical disciplinary action (prescription, alcohol, and drug related), prescribers exceeding a set threshold of controlled substance prescription, number of patients with alerts visiting a prescriber, location of the prescriber, and percentage of patients paying the prescriber with cash.

In another aspect, the data of indicators may include, without limitation, data corresponding to a dispenser, which includes the number of pharmacies visited by the patient, percent or cash payments, percent of controlled substances dispensed, number of controlled substances filled, number of patients with alerts, location, ratio inventory of controlled substances vs. uncontrolled prescription dispensed, and number of controlled substances ordered by the dispensers.

In a further aspect of the invention, a high abuse or diversion likelihood score, indicating high probability of abuse or diversion, is assigned when the patient data and the data of indicators overlap and where the overlap is high. A low abuse or diversion likelihood score, indicating low probability of abuse or diversion, is assigned when the patient data and the data of indicators overlap and where the overlap is low.

The overlap and the determination of whether the overlap is high or low can be computed by a summation of weighted matches between the patient data and the data of indicators. For example, in a simple instance, a weight assigned to a Schedule-I drug (e.g. heroin) is high, and the patient with such an overlap/match is assigned a high score. The weight of indicators may change as research evidence further supports or refutes an indicator as it relates to the likelihood of abuse or diversion.

In a more involved case, the weights may be variable, for example, where two patients A and B use the same controlled substance but patient B has had a prior drug related conviction. In such a case, the weight for a match for patient A will be low, whereas for patient B will be high. In addition, patient B's abuse or diversion likelihood score will include an additional component for the prior conviction.

In some cases the weight may be negative. This would be in a case, for example, where a patient has cancer and is using pain medication. The amount of pain medication and its frequency used by the cancer patient may contribute to a high abuse or diversion likelihood score. However, a diagnosis of late stage cancer would contribute a sufficiently large negative weight so as to override an otherwise high abuse or diversion likelihood score.

In some instances, an authorized user of the method may permanently set the abuse or diversion likelihood score high or low as needed.

In a further aspect of the invention, the abuse or diversion likelihood score is used for decision making by prescribers, dispensers, law enforcement, government agencies, research organizations, regulatory or licensing agencies, insurance agencies, parole boards, or by predictive modeling software.

In another embodiment, the invention is a computer readable medium comprising computer executable instructions recorded thereon for performing the method of predicting abuse or diversion of one or more controlled substances. The method involves identifying a patient, accessing one or more databases containing patient data, comparing patient data with data of indicators of abuse or diversion, and assigning abuse or diversion likelihood score to the patient. The patient may be identified by a user of the program.

The term “computer-readable medium”, without limitation, includes any medium that can store or transfer information, including volatile, nonvolatile, removable and non-removable memory or media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk, or any other medium which can be used to store the desired information and which can be accessed. A computer data signal includes any signal that can propagate over a transmission medium such as electronic network channels, optical fibers, air, electromagnetic, RF links, etc. Code segments may be downloaded via computer networks such as the Internet or an intranet. In any case, the scope of the present disclosure should not be construed as limited by such embodiments.

Computer-executable instructions comprise, without limitation, instructions and data which, when executed, cause a computer or a processing device to perform a certain function or a group of functions. The computer executable instructions may be, for example, shell-script, binaries, intermediate format instructions such as assembly language, or source code or object code.

Aspects of the invention relating to controlled substances, databases containing patient data, data of indicators, and assignment of abuse or diversion likelihood scores are as described in the above section.

In a further aspect of the invention, the abuse or diversion likelihood score is computed, without limitation, at fixed intervals. A plot of the variation of the score with time and inflections therein can be presented such as that shown in FIG. 8.

In another aspect of the invention, the abuse or diversion likelihood score is computed, without limitation, before the patient's visit, after the patient's visit, or during the patient's visit to the prescriber or to the dispenser. This enables the prescriber or the dispenser to actively track the patient's compliance.

In yet another aspect of the invention, the abuse or diversion likelihood score is displayed, without limitation, in a format of user's choice. For example, the abuse or diversion likelihood score can be in the numerical range: 0-100. The score also may be coded by a color; for example: red is be used to indicate high alert, green indicates a very low score, and shades of yellow, amber and orange may be used for the scores in between. The colors are illustrated as dotted fills in the embodiment of FIG. 7.

In yet another aspect of the invention, a display of location information is presented. For example, location information, without limitation, can be presented on a map, as shown in FIG. 9. In this example, a location on the map may be highlighted in a color different from the background color, and the shade of the highlight turns darker with the number of visits. As another example, the size of the highlight turns larger with the number of visits. As yet another example, the highlight may be color coded to indicate the level of abuse or diversion likelihood score contribution (to a specific patient and in general) from the location; for example, a location prescribing or dispensing a large quantity of opiates may be coded with a red highlight.

In another aspect of the invention, a display of the timeline of visits to the prescriber or timeline of prescriptions is presented. For example, the display, without limitation, can be grouped by the location of visit. In yet another example, without limitation, the display is grouped by the type of controlled substance prescribed.

In another aspect of the invention, the above-mentioned display, without limitation, is presented via a pull notification. For example, a pharmacist clicks on a few web links and determines the patient's abuse or diversion likelihood score.

In another aspect of the invention, the display, without limitation, is presented via push notification. For example, a doctor receives an email on a mobile device, which alerts her to the high abuse or diversion likelihood score of a scheduled patient.

In one embodiment, the software of this invention is integrated with other software, such other software, without limitation, includes a Health Information Exchange (HIE) program, an electronic medical record (EMR) program, or an electronic healthcare record (HER) program.

In another embodiment, the software of this invention is interfaced with other software, which can be achieved via an application programming interface (API).

In one embodiment, the present invention is a method of predicting abuse or diversion of one or more controlled substances. The method involves identifying a prescriber, accessing one or more databases containing prescriber data, comparing prescriber data with data of indicators of abuse or diversion, and assigning an abuse or diversion likelihood score to the prescriber.

The prescriber may be identified by a user of this method, where the user is any individual or a program (which may be run by a person or scheduled to run automatically).

In one aspect, the databases containing prescriber data, without limitation, incorporate data provided by a regulatory authority. The regulatory authority, without limitation, in one instance is a drug testing authority (government or non-government), a law enforcement authority, a legal system, a healthcare licensing or healthcare credentialing authority, a state medical board, a state pharmacy board, a state nursing board, a state veterinary board, a state chiropractic board, a state dental board, a state podiatry boards, a department of transportation, a state bar, or the like.

In another aspect, the databases containing prescriber data incorporate data provided, without limitation, by a prescription or a prescriber. The prescriber, without limitation, can be a doctor, a physician assistant, a nurse practitioner, a dentist, a veterinarian, a podiatrist, a chiropractor, any individual or entity legally authorized to prescribe controlled substances, or any individual or entity ill-legally prescribing a controlled substance.

In another aspect, the databases containing prescriber data incorporate data provided, without limitation, by a dispenser. The dispenser, without limitation, can be a pharmacy, a pharmacist, a physician or a physician's authorized agent, such as a nurse practitioner or physician assistant dispensing under the license of the physician.

In an aspect, the databases containing prescriber data incorporate data provided, without limitation, by a supplier. The supplier, without limitation, can be a brand name supplier, a generic supplier, a pharmacy warehouse, a wholesaler, or a distributer.

In another aspect, the databases containing prescriber data incorporate data provided, without limitation, by a compounder, an importer, an exporter, a manufacturer, a toxicology report, a drug-testing or a clinical laboratory, or a healthcare provider.

In one aspect, the databases containing prescriber data incorporate data provided, without limitation, by an insurance provider or third-party payer, a government agency, a credit bureau, a research organization, a pharmacy or healthcare benefits manager, a Health Information Exchange (HIE), an electronic medical record (EMR) or electronic healthcare record (EHR), a pharmacy benefits manager, a financial institution, a communications company, an internet or web-based services provider (hosting, data tracking, search engines, a mobile device content or advertisement provider), a GPS or other location-tracking provider, a face-recognition or other bio-identification company, a surveillance company, a security company, or a data analytics company.

In another aspect the databases containing prescriber data incorporate data provided, without limitation, by user input.

In a further aspect, the data of indicators may include, without limitation, data relating to a controlled substance. The controlled substance, without limitation, may be any substance as defined by the Drug Enforcement Administration (DEA) in Title 21 Code of Federal Regulations (C.F.R.) §§1308.11 through 1308.15. The lists of Schedule I-V controlled substances are herein incorporated by reference. Any other drug, alcohol, and beverages thereof that can be abused or diverted are also considered as controlled substances.

In general Schedule I-Schedule V drugs are assigned priority—high to low, in the same order, for the purpose of assigning an abuse or diversion likelihood score. The following drugs are also given higher priority for the purpose of assigning abuse or diversion likelihood score: opiates/opioids such as hydrocodone, oxycodone, morphine, fentanyl, buprenorphine, suboxone (buprenorphine/naloxone), codeine, hydromorphone and methadone; muscle relaxants such as carisoprodol (soma); CNS depressants such as Benzodiazepines (examples: alprazolam, lorazepam, clonazepam, diazepam), Baribiturates (examples: phenobarbital, Nembutal, butalbital, and amobarbital), and other sedative/hypnotics such as zolpidem; CNS stimulants such as amphetamine, methamphetamine, methylphenidate, phentermine, modafanil (provigil) and armodafanil (nuvigil); and anabolic steroids. This list is not all-inclusive and may cover all controlled substances currently regulated by the U.S. Controlled substances Act, as well as new compounds that may have any abuse or diversion or diversion potential.

The number of prescriptions written, multiple prescriptions to a single patient, multiple classes of controlled substances to a single patient, self-prescription, percent of controlled substance prescribed, and exceeding a set threshold in given time can be all included, without limitation, in the data of indicators.

In another aspect, the data of indicators, without limitation, includes data of a regulatory authority. Such data is acquired, without limitation, from law enforcement authorities, judicial authorities, medical boards (disciplinary actions: prescription, drug or alcohol related) and PDMP (Prescription Drug Monitoring Programs) maintaining authorities.

In yet another aspect, the data of indicators, without limitation, includes data relating to a location, including information concerning where the prescriptions are filled and patients' addresses.

In another aspect, the data of indicators, without limitation, includes data relating to the type of patients, including the number of patients with alerts (indicated by the current method or by any other means), the number of patients with history of controlled substance abuse or diversion, and/or the number of patients paying with cash.

In a further aspect of the invention, a high abuse or diversion likelihood score, indicating high probability of abuse or diversion, is assigned when the prescriber data and the data of indicators overlap and where the overlap is high. A low abuse or diversion likelihood score, indicating low probability of abuse or diversion, is assigned when the prescriber data and the data of indicators overlap and where the overlap is low.

The overlap and the determination of whether the overlap is high or low can be computed by a summation of weighted matches between the prescriber data and the data of indicators. For example, a prescriber who self-prescribes a controlled substance will be given high abuse or diversion likelihood score. The score will be higher if there is another match, for example, a number of the prescriber's patients have prescriptions for opiates.

In some instances an authorized user of the method may permanently set the abuse or diversion likelihood score high or low as needed.

In a further aspect of the invention the abuse or diversion likelihood score is used, without limitation, for decision making by dispensers, law enforcement, government agencies, research organizations, regulatory or licensing agencies, insurance agencies, parole boards, or by predictive modeling software.

In another embodiment, the methods are implemented in a computer readable medium comprising computer executable instructions recorded thereon for performing the method of predicting abuse or diversion of one or more controlled substances. The methods may include identifying a prescriber, accessing one or more databases containing prescriber data, comparing prescriber data with data of indicators of abuse or diversion, and assigning abuse or diversion likelihood score to the prescriber.

The prescriber may be identified by a user of this method, where the user is any individual or a program (which may be run by a person or scheduled to run automatically).

The terms “computer-readable medium” and “computer executable instructions” are as described in the preceding sections. Aspects of the invention relating to controlled substances, databases containing prescriber data, data of indicators, and assignment of abuse or diversion likelihood scores are as described in the above section.

In a further aspect of the invention, the abuse or diversion likelihood score is computed, without limitation, at fixed intervals and before disciplinary board meetings. A plot of the variation of the score with time and inflections therein can be presented.

In another aspect of the invention the abuse or diversion likelihood score is computed, without limitation, before the prescriber's visit, after the prescriber's visit, or during the prescriber's visit to the dispenser. This enables the dispenser to actively track the prescriber's score and query the need for a selected prescription.

In yet another aspect of the invention, the abuse or diversion likelihood score is displayed, without limitation, in a format of user's choice. For example, the abuse or diversion likelihood score can be in the numerical range: 0-100. The score also may be coded by a color code; for example: red is used to indicate high alert, green may indicate a very low score, and shades of yellow, amber and orange may be used for the scores in between.

In yet another aspect of the invention, a display of location information is presented. For example, location information, without limitation, can be presented on a map. In this example, a location on the map is highlighted in a color different from the background color, and the shade of the highlight turns darker with the number of visits. As another example, the size of the highlight turns larger with the number of visits. As yet another example, the highlight may be color coded to indicate the level of abuse or diversion likelihood score contribution (to a specific patient or prescriber and in general) from the location; for example, a location prescribing or dispensing a large quantity of opiates is coded with a red highlight.

In another aspect of the invention, a display of the timeline of prescriptions is presented. For example, the display, without limitation, is grouped by the frequency of prescriptions. In another example, the display, without limitation, is grouped by the type of controlled substance prescribed.

In another aspect of the invention, the timeline of disciplinary actions against the prescriber can be presented, where recent actions are highlighted.

In another aspect of the invention, the above-mentioned display, without limitation, is presented via a pull notification. For example, a pharmacist clicks on a few web links and determines a prescriber's abuse or diversion likelihood score.

In another aspect of the invention, the display, without limitation, is presented via push notification. For example, an authorized person at the state medical board receives an email that alerts her to the high abuse or diversion likelihood score of a certain physician.

In one embodiment, the software of this invention is integrated with other software, such other software, without limitation, includes a Health Information Exchange (HIE) program, an electronic medical record (EMR) program or an electronic healthcare record (EHR) program.

In another embodiment, the software of this invention is interfaced with other software, which can be achieved via an application programming interface (API).

The methods may also include identifying a dispenser, accessing one or more databases containing dispenser data, comparing dispenser data with data of indicators of abuse or diversion, and assigning an abuse or diversion likelihood score to the dispenser.

In one aspect, the databases containing dispenser data, without limitation, incorporate data provided by a regulatory authority. The regulatory authority, without limitation, in one instance is a drug testing authority (government or non-government), a law enforcement authority, a legal system, a healthcare licensing or healthcare credentialing authority, a state medical board, a state pharmacy board, a state nursing board, a state veterinary board, a state chiropractic board, a state dental board, a state podiatry boards, a department of transportation, a state bar, or the like.

In another aspect, the databases containing dispenser incorporate data provided, without limitation, by a prescription or a prescriber. The prescriber, without limitation, can be a doctor, a physician assistant, a nurse practitioner, a dentist, a veterinarian, a podiatrist, a chiropractor, any individual or entity legally authorized to prescribe controlled substances, or any individual or entity ill-legally prescribing a controlled substance.

In another aspect, the databases containing dispenser data incorporate data provided, without limitation, by a dispenser. The dispenser, without limitation, can be a pharmacy or a pharmacist.

In another aspect, the databases containing dispenser data incorporate data provided, without limitation, by a supplier. The supplier, without limitation, can be a brand name supplier, a generic supplier, a pharmacy warehouse, a wholesaler, or a distributer.

In another aspect, the databases containing dispenser data incorporate data provided, without limitation, by a compounder, an importer, an exporter, a manufacturer, a toxicology report, a drug-testing or a clinical laboratory, or a healthcare provider.

In another aspect, the databases containing dispenser data incorporate data provided, without limitation, by an insurance provider or third-party payer, a government agency, a credit bureau, a research organization, a pharmacy or healthcare benefits manager, a Health Information Exchange (HIE), an electronic medical record (EMR) or electronic healthcare record (HER), a pharmacy benefits manager, a financial institution, a communications company, an internet or web-based services provider (hosting, data tracking, search engines, a mobile device content or advertisement provider), a GPS or other location-tracking provider, a face-recognition or other bio-identification company, a surveillance company, a security company, or a data analytics company.

In another aspect, the databases containing dispenser data incorporate data provided, without limitation, by user input.

In a further aspect, the data of indicators may include, without limitation, data relating to a controlled substance. The controlled substance, without limitation, may be any substance as defined by the Drug Enforcement Administration (DEA) in Title 21 Code of Federal Regulations (C.F.R.) §§1308.11 through 1308.15. The lists of Schedule I-V controlled substances are herein incorporated by reference. Any other drug, alcohol, and beverages thereof that can be abused or diverted are also considered as controlled substances.

In general Schedule I-Schedule V drugs are assigned priority—high to low, in the same order, for the purpose of assigning an abuse or diversion likelihood score. The following drugs are also given higher priority for the purpose of assigning abuse or diversion likelihood score: opiates/opioids such as hydrocodone, oxycodone, morphine, fentanyl, buprenorphine, suboxone (buprenorphine/naloxone), codeine, hydromorphone and methadone; muscle relaxants such as carisoprodol (soma); CNS depressants such as Benzodiazepines (examples: alprazolam, lorazepam, clonazepam, diazepam), Baribiturates (examples: phenobarbital, Nembutal, butalbital, and amobarbital), and other sedative/hypnotics such as zolpidem; CNS stimulants such as amphetamine, methamphetamine, methylphenidate, phentermine, modafanil (provigil) and armodafanil (nuvigil); and anabolic steroids. This list is not all-inclusive and may cover all controlled substances currently regulated by the U.S. Controlled substances Act, as well as new compounds that may have any abuse or diversion or diversion potential.

In another aspect, the data of indicators may include, without limitation, data of a regulatory authority, where such data is acquired from law enforcement authorities, judicial authorities, medical boards (disciplinary actions: prescription, drug, or alcohol related) or PDMP (Prescription Drug Monitoring Programs) maintaining authorities.

In another aspect, the data of indicators may include, without limitation, data relating to a location, such as location information with regards to where the prescriptions are prescribed and addresses of patients.

In another aspect, the data of indicators may include, without limitation, data relating to the type of patients, the number of patients with alerts (indicated by the methods of the present invention or by any other means), the number of patients with history of controlled substance abuse or diversion, or the number of patients paying with cash vs. insurance.

In another aspect, the data of indicators may include, without limitation, data relating to the dispensing of controlled substance, the number of prescriptions, multiple prescriptions to a single patient, multiple classes of controlled substance to a single patient, percent of controlled substance dispensed, exceeding a set threshold in a given time, or the ratio of inventory of controlled substances vs. uncontrolled prescription dispensed.

In another aspect, the data of indicators may include, without limitation, data relating to the ordering of a controlled substance, orders placed to pharmacy warehouses, ratio of orders of controlled vs. uncontrolled substances, ratios when compared to other pharmacies, and change in ratios over time.

In another aspect of the invention, a high abuse or diversion likelihood score, indicating high probability of abuse or diversion, is assigned when the dispenser data and the data of indicators overlap and where the overlap is high. A low abuse or diversion likelihood score, indicating low probability of abuse or diversion, is assigned when the dispenser data and the data of indicators overlap and where the overlap is low.

The overlap and the determination of whether the overlap is high or low can be computed by a summation of weighted matches between the dispenser data and the data of indicators.

In some instances an authorized user of the method may permanently set the abuse or diversion likelihood score high or low as needed.

In a further aspect of the invention, the abuse or diversion likelihood score is used for decision making by prescribers, law enforcement, government agencies, research organizations, regulatory or licensing agencies, insurance agencies, parole boards, or by predictive modeling software.

In another embodiment, the methods may be implemented in a computer readable medium comprising computer executable instructions recorded thereon for performing the method of predicting abuse or diversion of one or more controlled substances. The methods may include identifying a dispenser, accessing one or more databases containing dispenser data, comparing dispenser data with data of indicators, and assigning an abuse or diversion likelihood score to the dispenser.

The terms “computer-readable medium” and “computer executable instructions” are as described in the preceding sections. Aspects of the invention relating to controlled substances, databases containing dispenser data, data of indicators, and assignment of abuse or diversion likelihood score are as described in the above sections.

Aspects of the invention relating to controlled substances, databases containing dispenser data, data of indicators, and assignment of abuse or diversion likelihood scores are as described in the above section.

In a further aspect of the invention, the abuse or diversion likelihood score is computed, without limitation, at fixed intervals and before disciplinary board meetings. A plot of the variation of the score with time and inflections also can be presented.

In yet another aspect of the invention, the abuse or diversion likelihood score is displayed, without limitation, in a format of user's choice. For example, the abuse or diversion likelihood score can be in the numerical range: 0-100. The score also may be coded by a color; for example: red is used to indicate high alert, green indicates a very low score, and shades of yellow, amber, and orange may be used for the scores in between.

In yet another aspect of the invention, a display of location information is presented. For example, location information, without limitation, can be presented on a map. In this example, a location on the map is highlighted in a color different from the background color, and the shade of the highlight turns darker with the number of visits. As another example, the size of the highlight turns larger with the number of visits. As yet another example, the highlight may be color coded to indicate the level of abuse or diversion likelihood score contribution (to a specific patient or prescriber and in general) from the location; for example, a location prescribing or dispensing large quantity of opiates is coded with a red highlight.

In another aspect of the invention, a display of the timeline of filled prescriptions is presented. For example, the display can be grouped, without limitation, by the frequency of filled prescriptions or by the type of controlled substance dispensed.

In another aspect of the invention, the timeline of disciplinary actions against the dispenser can be presented, where recent actions are highlighted.

In another aspect of the invention, the above-mentioned display is presented, without limitation, via a pull notification. For example, a doctor clicks on a few web links and determines the patient-requested dispenser's abuse or diversion likelihood score.

In another aspect of the invention, the display is presented, without limitation, via push notification. For example, an authorized person at the state board receives an email, which alerts her to the high abuse or diversion likelihood score of a pharmacy location.

In one embodiment, the software of this invention is integrated with other software, such other software, without limitation, includes a Health Information Exchange (HIE) program, an electronic medical record (EMR) program, or an electronic healthcare record (EHR) program.

In another embodiment, the software of this invention is interfaced with other software, which can be achieved via an application programming interface (API).

### Example 1

Leslie Johnson, a 49 year-old woman with 2 teenage boys, called into Dr. Winton's office to refill her monthly prescription of oxycodone, which she had been taking for severe osteoarthritis. Noting that Leslie was more than a week early for a refill, Dr. Winton used an embodiment of the present invention to search her records, which, through an appropriately tuned data of indicators, showed a pattern of increasingly early refills over the previous 5 months and hence a high abuse or diversion likelihood score (of 98). In response to Dr. Winton's questions about adherence, Leslie proudly explained that she takes her medicine as prescribed, never deviating from his instructions. Thinking out loud about why her pills had not lasted through the entire month, Leslie revealed that one of her sons had recently been skipping school and socializing with older boys who had been in trouble with the law. When Dr. Winton asked about access to the pills, Leslie answered that she kept all her medicines in an unlocked cabinet in her house's only bathroom. Raising the possibility that Leslie's son or his friends might be diverting the oxycodone pills, Dr. Winton suggested that she keep them in a more secure place, educated her on proper medication storage, and suggested that she have her son evaluated for possible substance abuse or diversion issues. Additionally, Dr. Winton gave the patient a urine drug screen and followed up with urine drug screens every month for the next six months.

Over the next six months, Leslie's abuse or diversion likelihood score decreased, as she no longer required early refills, and her urine screens came back consistently as expected.

### Example 2

Jason was admitted to a treatment facility for polypharmacy addiction. He was found to have multiple drugs in his system, including benzodiazepines, cocaine, and opioids. Jason was weaned off the Xanax with clonazepam and opioids with suboxone, respectively.

After 28 days, Jason left treatment and was followed by the rehab's aftercare program, which consisted of monthly urine screens, group and individual therapy, as well as other activities to help minimize risk of relapse. His urine drug screens (further described below) showed his progression as he was weaned off the drugs he abused or diverted, and once stabilized on suboxone and clonazepam, he was tapered off of those medications.

The urine test results from the day of admission as well as all subsequent test results were entered into a database that an embodiment of the present invention accesses. At the end of the year, a rehab doctor, Dr. Watson, uses an embodiment of the present invention, having an appropriately tuned data of indicators, and finds that Jason has a high abuse or diversion likelihood score (of 95), at least because his urine test results show increasing levels of clonazepam metabolites in the recent months. This was not consistent with the prescription provided by the rehab facility or by Dr. Watson. The concerned authorities are alerted of Jason's non-compliance through a feature of the present invention, which can be accomplished through web links or other supported reporting tools.

### Example 3

Jamie is a 38 year-old woman with breast cancer, who underwent a bilateral mastectomy 2 years ago along with four cycles of chemotherapy. While she is considered to be without any evidence of disease, Jamie now suffers from post-surgical chronic pain with constant sharp, stabbing pain along the surgical lines. She has been taking gabapentin, which helps decrease the pain somewhat.

Jamie has also been taking hydrocodone/acetaminophen, 10 mg/325 mg, three times per day for the last 2 years. Jamie has made only one early refill request, which she stated was because she was going on vacation for 2 weeks. Jamie signed an opioid contract and had a baseline urine drug test before starting the hydrocodone. Jamie has had random urine tests throughout her treatment, and has never had a positive test.

Jamie is now applying for an office job with the Department of Transportation and must disclose her use of hydrocodone and now requests a note from her pain doctor, Dr. Winton.

Using an embodiment of the present invention, Dr. Winton searches for Jamie and finds a low abuse or diversion likelihood score (25) and a graph of the score showing her consistent accountability and compliance with her opioid contract and her physician. Upon seeing this data, Dr. Winton is able to write the letter of compliance and advocate for Jamie, as her compliance with her treatment plan and her responsible use of opioid pain medication is well documented in her EMR and easy to confirm for use of advocating on her behalf.

Sample Outputs

FIG. 10 is a screenshot diagram illustrating one embodiment of a user interface screen produced by a system for generating a clinical presentation related to controlled substance abuse and diversion. In an embodiment the user interface may include a menu 1002 comprising one or more interactive buttons 1006 for navigating application functions, such as searching for patients, printing reports, account settings, etc.

In an embodiment an interactive button 1006 includes an option for referring a patient to another service provider, such as a pain specialist, addiction specialist, psychiatrist, etc. In an embodiment, the geolocating functions may be used to generate a map of potential referrals based on a geolocating algorithm based on either the patient's zip code, or the service provider's zip code. Alternatively, the geolocating algorithm may use Global Positioning System (GPS) data provided by the user interface device 110 to identify one or more service providers. In a further embodiment, the service providers may be identified by a selected classification or category of service provider.

In one embodiment, the referral screen may be automatically triggered in response to a determination that the patient has a high risk score, and that the patient is seeking a further prescription for a controlled substance. In another embodiment, the referral control button 1006 may be selectable by the service provider. In response to activation of the referral function, a referral letter, including address information and/or a map to the referred service provider, may be automatically generated.

In addition, the user interface may include one or more clinical decision feedback buttons for collecting a survey of information about whether the graphical display was helpful to the service provider in determining a clinical treatment result.

The user interface of FIG. 10 may also include a timeline having a plurality of bubbles 1008, each bubble describing a medication prescribed to the patient. The bubbles 1008 may include an indicator of the quantity of medication prescribed 1010, and indicator of the service provider who prescribed the medication 1012, and an indicator of the medication prescribed 1014. Each bubble 1008 may be color coded according to, for example, the prescription name or classification of prescription.

The user interface may also include patient information, including an indicator of the patient's risk score 1015. Selection, or hovering over, any of the bubbles 1008 may display a further information box 1016 which provides further information about the selected prescription, including the prescription name, the date prescribed, date filled, strength, quantity, number of refills, and pharmacy. One of ordinary skill may recognize additional information which could be included.

A provider information legend 1018 may provide a consolidated list or summary of the prescribed medication, and may also provide notices or red flags prompting the service provider to seek additional information, or make additional inquiries of the patient. In addition, a clinical feedback form 1020 may be provided for the service provider to make notes, or provide additional feedback.

FIGS. 11A-11D are screenshot diagrams illustrating one embodiment of a report produced by a system for generating a clinical presentation related to controlled substance abuse and diversion. The report may include a timeline section 1102 and a monthly digest of prescription activity 1104. Additionally, the report may include a legend 1106 of medication classifications, the shapes listed in the legend corresponding to one or more shapes 1108 shown in the timeline bubbles. Such an embodiment may be preferable for printing the report in black and white format. The monthly digest 1004 may provide a month-by-month summary of prescription activity, including information 1110 about each prescription during the month. The monthly digest 1104 may include 12 months of data in one embodiment, as shown in FIGS. 11A-11D. Months with no prescription activity may remain blank, as shown in the “February '2016” field. Months with multiple prescriptions may show a prescription information block 1110 for each prescription, as shown in December '2015 field of FIG. 11B.

All patents, patent publications, patent applications, and other references identified in the present specification are individually and expressly incorporated herein by reference in their entirety for the purpose of describing and disclosing, for example, the compositions and methodologies described in such references that might be used in connection with the present invention. These references are provided solely for their disclosure prior to the filing date of the present application. Nothing in this regard should be construed as an admission that the inventor is not entitled to antedate such disclosure by virtue of prior invention or for any other reason. All statements as to the date or representation as to the contents of these documents is based on the information available to the applicants and does not constitute any admission as to the correctness of the dates or contents of these documents.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method of predicting abuse or diversion of one or more controlled substances, comprising:
identifying a potential abuser or diverter;
accessing one or more databases containing abuser or diverter data;
comparing said abuser or diverter data with data of abuse or diverter indicators;
assigning an abuse or diversion likelihood score to the potential abuser or diverter; and
generating a graphical representation of the data obtained from the data source to provide information necessary to effectively evaluate a need for further prescriptions.

2. The method of claim 1 wherein assigning an abuse or diversion likelihood score further comprises performing a summation of weighted matches between the abuse or diverter data and the data of indicators.

3. The method of claim 1 wherein the database containing abuser or diverter data comprises a Prescription Drug Monitoring Program (PDMP) database.

4. The method of claim 1 further comprising receiving patient data over an encrypted patient data input interface.

5. The method of claim 1, further comprising referring to one or more predetermined rules in a rules engine to determine the need for further prescriptions.

6. The method of claim 1, further comprising analyzing the abuser or diverter data to discover a prescription usage trend.

7. The method of claim 1, further comprising color coding the graphical representation to highlight a classification of drug prescribed.

8. The method of claim 1, further comprising displaying an indicator of the abuse or diversion likelihood score on the graphical representation.

9. The method of claim 1, further comprising displaying prescription dosage information on the graphical representation.

10. The method of claim 1, further comprising displaying prescription volume on the graphical representation.

11. A system for predicting abuse or diversion of one or more controlled substances, comprising:
a patient data input interface configured to receive identification of a potential abuser or diverter;
secondary data input interface configured to access one or more databases containing abuser or diverter data;
a processor configured to:
compare the abuser or diverter data with data of abuse or diverter indicator;
assign an abuse or diversion likelihood score to the potential abuser or diverter; and
generate a graphical representation of the data obtained from the data source to provide information necessary to effectively evaluate a need for further prescriptions.

12. The system of claim 11 wherein assigning an abuse or diversion likelihood score further comprises performing a summation of weighted matches between the abuse or diverter data and the data of indicators.

13. The system of claim 11 wherein the database containing abuser or diverter data comprises a Prescription Drug Monitoring Program (PDMP) database.

14. The system of claim 11 wherein the patient data input interface is configured to receive patient data over an encrypted patient data input interface.

15. The system of claim 11, further comprising a rules engine configured to refer to one or more predetermined rules in a rules engine to determine the need for further prescriptions.

16. The system of claim 11, further comprising a trend discovery tool configured to analyze the abuser or diverter data to discover a prescription usage trend.

17. The system of claim 11, further comprising color coding the graphical representation to highlight a classification of drug prescribed.

18. The system of claim 11, further comprising displaying an indicator of the abuse or diversion likelihood score on the graphical representation.

19. The system of claim 11, further comprising displaying prescription dosage information on the graphical representation.

20. The system of claim 11, further comprising displaying prescription volume on the graphical representation.
